(19) United States
(12) Patent Application Publication
(10) Pub. No.: US 2008/0306768 A1
(43) Pub. Date: Dec. 11, 2008

(54) Healthcare Notification Method And System Including A Healthcare Website

(75) Inventors: Edward J. Fotsch, Sausalito, CA (US); Debra Del Guidice, Sausalito, CA (US); Nick Krym, Castro Valley, CA (US); Leslie Yuan, San Francisco, CA (US)

Correspondence Address: VIERRA MAGEN MARCUS & DENIRO LLP, 575 MARKET STREET SUITE 2500, SAN FRANCISCO, CA, 94105, US

(73) Assignee: Medem, Inc., San Francisco, CA (US)

(21) Appl. No.: 12/175,078

(22) Filed: Jul. 17, 2008

Related U.S. Application Data
(63) Continuation-in-part of application No. 11/086,118, filed on Mar. 21, 2005.

(51) Int. Cl. G06Q 50/00

(52) U.S. Cl. 705/2

(57) ABSTRACT

Methods and apparatus enabling organizations with a need to communicate with healthcare providers regarding health-related issues affecting patient health to notify healthcare providers of a health-related issue affecting patient health are disclosed. An electronic notification of the health-related issue is transmitted by one of the organizations to a healthcare notification network, which may include a healthcare website, for transmission to a healthcare provider, where the electronic notification includes a mechanism for obtaining an acknowledgement indicating that the healthcare provider has received and opened the electronic notification. The acknowledgement is then received by the healthcare website from the healthcare provider, where the acknowledgement indicates that the healthcare provider has received and opened the electronic notification. Healthcare information, such as drug recalls and medication warnings to healthcare providers from content providers, along with other services, is provided at the healthcare website.

### CROSS-REFERENCE TO RELATED APPLICATIONS

This application is related to Attorney Docket No. MEDE-01000US0, patent application Ser. No. 10/387,041, entitled “HEALTHCARE PROVIDER-PATIENT ONLINE CONSULTATION SYSTEM,” filed on Mar. 10, 2003, naming Fotsch et al. as inventors, which is incorporated herein by reference for all purposes.

This application is also related to Attorney Docket No. MEDE-01000US1, patent application Ser. No. 10/641,982, entitled “HEALTHCARE PROVIDER-PATIENT ONLINE CONSULTATION AND COMPLIANCE PROGRAM,” listing Fotsch et al. as inventors, filed on Aug. 15, 2003, which is incorporated herein by reference for all purposes.

This application is also related to Attorney Docket No. MEDE-01000US2, patent application Ser. No. 11/085,984, entitled “ELECTRONIC PERSONAL HEALTH RECORD SYSTEM,” filed Mar. 21, 2005, naming Fotsch et al. as inventors, which is incorporated herein for all purposes.

This application is also related to Attorney Docket No. MEDE-01000US3, patent application Ser. No. 11/208,144, entitled “ELECTRONIC PERSONAL HEALTH RECORD SYSTEM,” filed on Aug. 19, 2005, naming Fotsch et al. as inventors, which is incorporated herein for all purposes.

This application is also related to Attorney Docket No. MEDE-01002US0, patent application Ser. No. 11/362,644, entitled “METHOD, SYSTEM AND ARTICLE OF MANUFACTURE, SUCH AS A CARD, TO PROVIDE USER SELECTABLE MEDICAL INFORMATION AND INFORMATION TO OBTAIN ELIGIBILITY OF HEALTHCARE PAYMENTS,” filed on Feb. 27, 2006, naming Fotsch et al. as inventors, which is incorporated herein for all purposes.

This application is a continuation-in-part of pending U.S. patent application Ser. No. 11/086,118 [Attorney Docket No.: MEDE-01001US0], filed on Mar. 21, 2005 entitled, “HEALTHCARE NOTIFICATION SYSTEM.”

### FIELD OF THE INVENTION

The present invention relates to online healthcare notification.

### BACKGROUND

Timely, accurate, reliable and pervasive communication with physicians and patients is required for patient protection and safety, and for national defense against biological or communicable threats. But despite advancements in information and communication technology, most direct outreach to physicians and patients related to patient safety, product warnings or public health issues continue to rely on broadcast media and U.S. mail. Over 250 times each year, manufacturers, federal agencies and other third parties outreach directly to physicians, principally using the U.S. mail. Most of these messages relate not only to physicians themselves, but also directly to the patients in their care. These physicians, however, have no practical means by which to outreach to their patients and share the information, warnings, recalls or patient safety messages. In addition, mail-based physician outreach has inconsistent results and poor documentation.

Communicating efficiently and effectively with physicians and patients is critical to ensure patient and public safety. Manufacturers of healthcare products and services are at times required to contact physicians with information regarding their products and services. The information may be a product recall, warning, or other information of importance. In 2003 alone, there were a combined total of over 50 Class 1 FDA-mandated medication and device recalls, nearly all of which required direct notification of large numbers, typically hundreds of thousands, of physicians. In March 2004, over 100 medications had FDA-approved label changes, most related to new contraindications and warnings. Currently, the principal method for communicating FDA-related product recalls or warnings directly to physicians is the U.S. mail. The current method for communicating FDA-related product recalls or warnings to patients/consumers is through press releases and media, and physician notification of their patients using telephone or U.S. mail.

In addition to FDA-related notifications, federal agencies and other public health advocates such as the Centers for Disease Control (the “CDC”) also have a need to communicate rapidly with physicians in the event of a natural disaster, communicable outbreak, bioterrorism or other similar events. For the most part, current communication to physicians by government agencies related to emergent public safety is via media, fragmented outreach to local health systems, or the US Mail. Federally funded AHRQ studies from 2002 and 2004 demonstrated that while information technology held clear promise as a vehicle for physician communication in the event of emergent public health needs, the current notification systems are fragmented and under-funded, leaving the country and its citizens vulnerable.

As set forth above, there are many circumstances requiring that physicians or other individuals be contacted regarding situations affecting public health and safety. For instance, product recalls, warnings or label changes on medications may affect the health and safety of individuals taking these medications. Other possible scenarios affecting groups of individuals may include attempts at bio-terrorism or local epidemic outbreaks. In these circumstances, it is important to notify the affected individuals in a timely manner. The Federal Drug Administration (FDA) and the Centers for Disease Control (CDC) are among those charged with the responsibility of ensuring that members of the public are notified when these situations arise. Typically, organizations such as the FDA, the CDC, and pharmaceutical companies (among others) communicate with physician practices via U.S. mail. However, there is no way to ensure that the physicians have opened their mail. Moreover, there is generally a significant time delay between the time that mail is sent and the time that mail is received. In fact, after printing and handling, the U.S. mail typically takes several days to reach addressees. Moreover, U.S. mail that is not delivered appropriately often results in no, or delayed, notification to the sender. In some circumstances, Federal Express may be used in urgent situations. However, this option is costly and therefore only done in rare circumstances. Moreover, even with Federal Express, a day can be a significant amount of time when a person's health or safety is involved. In addition, physicians' addresses often change without timely notification. Even when the physician has received the mailed notification, there is no guarantee that the physician will open his or her mail, or that the appropriate patients will be notified by the physician. Unfortunately, there is currently no efficient mechanism in place to enable physicians to notify their patients, often resulting in further notifications to be sent via U.S. mail, if at all.

In conjunction with product recalls, warnings and other similar notifications, the FDA will often mandate that the responsible manufacturer conduct follow up studies to determine the efficacy of the mailing. These studies involve making contact with the physicians to ensure that the letter was received and read, and that the physician then notified his or her patients of the health-related issue addressed in the letter sent to the physician. While it is possible to confirm delivery of U.S. mail, this confirmation is limited to receipt of the mail piece only. Unfortunately, there is no efficient way for such a company to perform this research to ensure that the physician actually received and read the notification, and then took the appropriate measures to ensure that his or her patients were notified.

In addition, the physician may require more information than is typically contained in the notification, and because the notification is paper-based, several more steps are required for the physician to obtain access to this additional information.

It is also important to note that there is currently no mechanism in place for notifying the affected individuals, such as patients of physicians or those who care for them, of the types of developments set forth above, nor is there any way to effect broader outreach to all individuals in a particular area, for example, when a local or regional health crisis occurs. This is also true and becomes even more challenging on a nationwide scale, when notification might be required in the event of a bioterrorism event. For this reason and due to the time delays involved with mailing health-related notifications to physicians, the FDA and the CDC often turn to the media, such as television or radio, to notify the public of emergency or health-related situations. In this manner, the general public may be notified in a more efficient manner. Unfortunately, there is no guarantee that the notifications or warnings will reach the desired individuals. In view of the above, it would be beneficial if a more efficient mechanism for notifying physicians and patients of health-related matters could be implemented.

### BRIEF DESCRIPTION OF THE DRAWINGS

FIG. 1 illustrates a system to distribute healthcare related information to healthcare providers and patients according to an embodiment.

FIGS. 2A-B illustrate a software architecture of healthcare platform software 102a illustrated in FIG. 1 according to an embodiment.

FIGS. 3A-C are flow charts to illustrate distributing healthcare related information to healthcare providers and patients according to an embodiment.

FIG. 4 illustrates a hardware architecture of healthcare platform processing device 102 shown in FIG. 1 according to an embodiment.

FIG. 5A illustrates a healthcare related notification in the form of a HTML web page 500 provided at healthcare website 101 shown in FIG. 1 according to an embodiment.

FIG. 5B illustrates a patient healthcare related notification 501 provided from a healthcare provider via healthcare website 101 shown in FIG. 1 according to an embodiment.

FIG. 6 illustrates a healthcare related notification with a healthcare provider survey in the form of a HTML web page 600 provided at healthcare website 101 shown in FIG. 1 according to an embodiment.

FIG. 7 is a diagram illustrating an exemplary system according to an embodiment.

FIG. 8A is an exemplary HTML email including a notification that may be transmitted to healthcare providers.

FIG. 8B is an exemplary non-HTML email with a link to an HTML web page including notification that may be transmitted to healthcare providers.

FIG. 8C is an exemplary HTML web page with notification and physician response survey that may be transmitted to healthcare providers.

FIG. 8D is an exemplary HTML notification with a physician response survey that may be transmitted to healthcare providers.

FIG. 9 is a diagram illustrating an exemplary system according to an embodiment.

### DETAILED DESCRIPTION

I. Overview

A healthcare website (or portal) provides time-sensitive, safety healthcare related notifications from organizations, such as healthcare agencies, medical device manufacturers and pharmaceutical manufacturers, to healthcare providers, such as physicians. The healthcare related notifications (also referred to herein as notifications or healthcare notifications) may affect the patients of the healthcare provider or the general population. Acknowledgement of the notifications, along with a suite of services, is provided at the healthcare website for healthcare providers.

In an embodiment, the healthcare website is provided by a system including a healthcare platform processing device that is coupled to the Internet along with associated software that generates the notifications from organizations to healthcare providers along with the suite of services.

A medical event or issues affecting a patient or the general population health may arise under a variety of circumstances. For instance, it may be necessary to notify physicians of product recalls or label changes on medications. Other possible scenarios affecting the general population may include bio-terrorism outbreaks or local epidemics. The Federal Drug Administration (“FDA”) and manufacturers are charged with the responsibility of notifying patients in the event of a product recall, warning or label change, and the Centers for Disease Control (“CDC”) and other government agencies bear the responsibility of notifying the public in the event of a local, regional or national public health threat. Thus, the organizations communicating with physicians via the healthcare website may include the FDA, CDC, and other federal agencies, as well as other companies or organizations, such as those that are governed by the FDA.

In accordance with an embodiment, FDA regulatory requirements are fulfilled and include notifying physicians of health-related issues. The FDA regulatory requirements also include a follow-up aspect ensuring that the physicians received the notification transmitted to them and that their patients were notified. In order to satisfy these regulatory requirements, a notification and acknowledgement system is provided as described in further detail below.

In accordance with another embodiment, a notification system and method is provided that enables organizations such as the CDC or FDA (or companies governed by the FDA) to make contact with physicians regarding issues affecting patient health. In an embodiment, the notification system and method enables a notification to be generated and transmitted via electronic mail on behalf of an organization to physicians. The electronic mail will include a link to the healthcare website that includes the notification, as well as a suite of other services.

In an embodiment, an acknowledgement is provided that enables an acknowledgement message to be transmitted back to the healthcare website (or in particular the healthcare platform processing device) and then reported to the corresponding organization. The acknowledgement message may be transmitted automatically or in response to input by the healthcare provider. In an embodiment, the acknowledgement message will indicate that the healthcare provider has received and opened the notification message. In another embodiment, the acknowledgement message may indicate that the healthcare provider has read and understands the notification. In yet another embodiment, the acknowledgement message may indicate that the healthcare provider will follow or has followed the instructions provided in the notification message or, alternatively, that the healthcare provider will notify or has notified patients of the issue affecting patient health that has been identified in the notification message.

Other services provided at the healthcare website may include accesses to related literature or a dialogue with peers or other healthcare providers regarding the notification or topics of a general nature. Access to other important information may influence the healthcare provider's action with regard to the received notification information.

In accordance with an embodiment, healthcare providers have access to a patient version of the notification and the ability to send the patient version to predetermined patients. This may be accomplished via a network in which the healthcare provider and the patients are members. (This network may be included in the system having the healthcare platform processing device, or a different network, from the system used by organizations to reach healthcare providers with the notification messages.) A healthcare provider may choose to send a notification message to all of their patients. Alternatively, a healthcare provider may select to identify the patients, to which the health-related issue pertains, thereby enabling the healthcare provider to send a notification message to a predetermined subset of patients.

In accordance with an embodiment, a healthcare provider may identify a subset of patients via an online health record system (or electronic database) that stores a plurality of patient records. By searching the online health record system, a healthcare provider may identify the subset of patients to which the health-related issue pertains.

Healthcare providers may have important information to share with the notifying organizations, regarding such things as adverse events or reactions, community observations, and other information that is crucial and time-sensitive. An additional service is provided to healthcare providers to share this important and time-sensitive information with the appropriate third parties. In accordance with yet another aspect of the invention, the healthcare website will provide physician-organization communications to report adverse reactions to medications and devices; healthcare findings resulting from a local or regional biological/communicable threats, outbreaks or other crisis. This reporting may be related to a current or prior notification or may be unrelated to the notification. This reporting may be to the appropriate pharmaceutical company or medical device manufacturer, federal agency including but not limited to the FDA, CDC, and other organizations that the physician desires to notify.

Still another service includes allowing healthcare providers access to pharmaceutical samples, when one being prescribed is recalled, has a black-box warning or label change that requires the physician to turn to another drug for his/her patients or when a physician needs medication available to treat local or regional disease outbreaks, bio-terrorism or other threats to patient safety. Facilitating access to sample ordering will allow healthcare providers to effectively and efficiently get to know new medications and facilitate patient access to medications immediately upon diagnoses.

In an embodiment, the healthcare website enables peer review of communications between organizations and healthcare providers. In particular, although healthcare providers may have direct access to the healthcare website to transmit messages, organizations may submit communications from healthcare providers for review by others before they can be transmitted to other healthcare providers. Others, or a governing body, then review the communications to ensure that it meets criteria for delivery to healthcare providers. When the communications meet the criteria, the communications or a portion thereof is transmitted to healthcare providers. Similarly, when responses or acknowledgments are received from healthcare providers, these responses may be compiled by the individuals associated with the organizations with regard to “fulfillment” of the action required of the communication.

Another service at the healthcare website allows healthcare providers the ability to refer back to notifications that have been sent. The ability to create a healthcare provider-specific repository of prior notifications for their reference purposes is important to the continued safe prescribing and monitoring of prescription drugs and medical devices, and to the continued safe practice of medicine for a physician, while treating a patient where a notification contains information that may validate an observation of a patient or population. Still yet another service, allows healthcare providers to save, file, or delete notifications, and retrieve notifications from their files for reference at a later date.

Another service at the healthcare website allows healthcare providers the ability to update their notification profile, to ensure its currency. Accordingly, time critical notifications will be provided in a manner that is most efficient for that particular healthcare provider. For example, one physician may prefer the notification sent directly to a wireless handheld device; while another physician would prefer the notification be provided to his office computer. In each case, the physician will receive the notifications in the most efficient manner based the physician's practice.

Another service at the healthcare website allows healthcare providers the ability to update their practice profile to ensure its currency. This practice profile may be included in healthcare platform software 102a or may be a profile used to provide practice information to patients and other healthcare providers from another source.

In an embodiment, the functionality of the healthcare website may be integrated into a portlet or applet within third party systems, including but not limited to physician practice electronic medical record systems, practice management systems, and other third party systems.

In the following description, numerous specific details are set forth in order to provide a thorough understanding of embodiments. It will be obvious, however, to one skilled in the art, that embodiments may be practiced without some or all of these specific details. In other instances, well known process steps have not been described in detail in order not to unnecessarily obscure a particular embodiment.

The present embodiments support online healthcare provider-organization notifications and acknowledgements via the Internet. In an example, the healthcare provider is a physician. Thus, the following example will refer to physician-organization communications. The terms healthcare provider and physician will be used interchangeably herein. However, it is important to note that the healthcare provider need not be a physician.

II. System

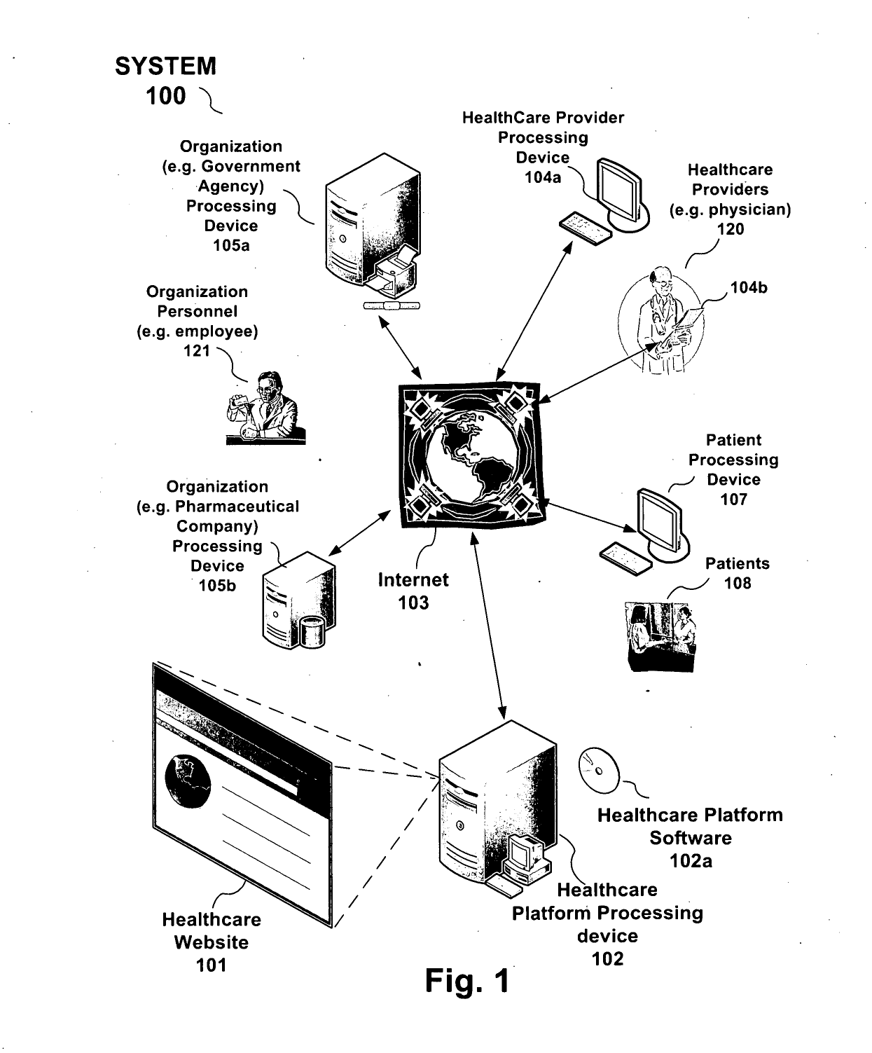

FIG. 1 illustrates a system 100 that provides time critical healthcare related information, along with other healthcare related services, in an efficient and timely manner to one or more selected healthcare providers 120. System 100 provides healthcare related electronic notifications from organizations or organization personnel 121 (via at least one organization processing device 105a/105b)) to selected healthcare providers 120 (via at least one healthcare processing device 104a-104b) based on the subject matter of the notice. In an embodiment, system 100 provides acknowledgement messages from a healthcare provider processing device that may include healthcare provider survey answers in response to receiving the healthcare related notification. Healthcare providers 120 may also generate healthcare related notifications to selected patients 108 (via at least patient processing device 107) based on the subject matter of the notification. System 100 includes a healthcare website 101 to provide healthcare related notifications including other healthcare related services to healthcare providers 120 and organization personnel 121.

Healthcare website 101 including healthcare related services are provided by healthcare platform processing device 102 and associated healthcare platform software 102a. For convenience, information is described herein as being transferred to and from healthcare website 101; however, one of ordinary skill in the art understands that information is actually transferred to and from healthcare platform processing device 102. Similarly for convenience, healthcare website 101 is described herein as processing information when in actuality processing device 102 and associate healthcare platform software 102a is actually performing the processing.

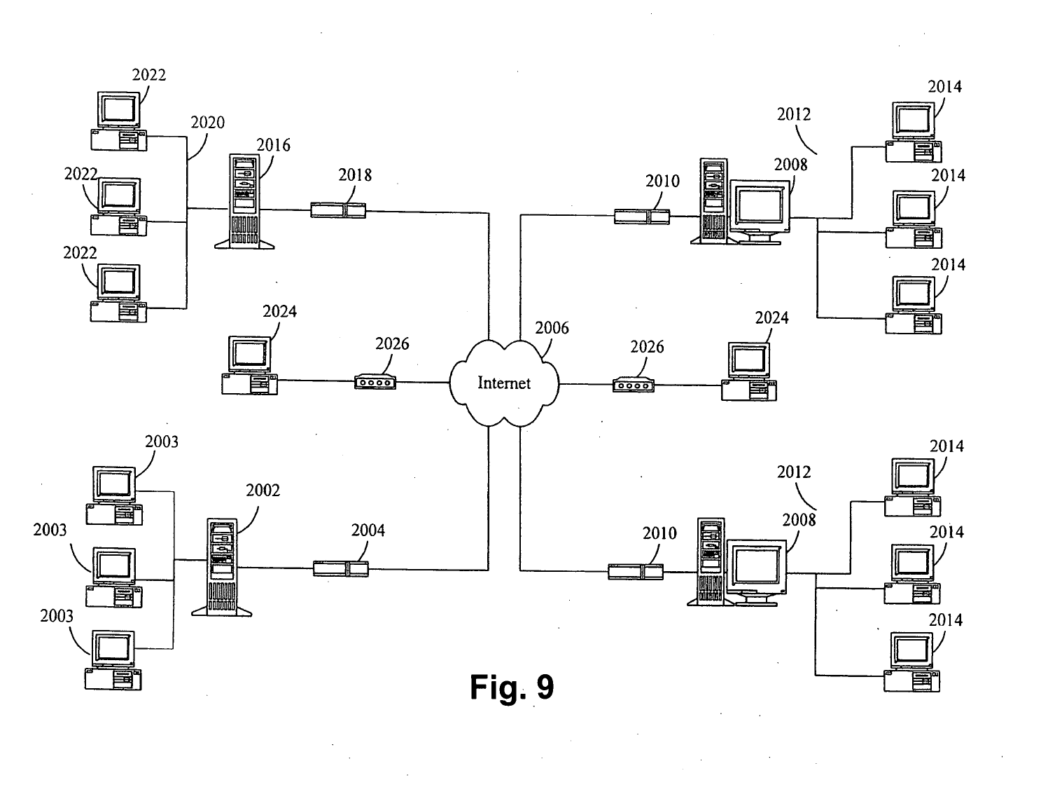

In an embodiment, processing devices 105a/b, 104a/b, 107 and 102 are coupled and communicate by way of Internet 103. In alternate embodiments, healthcare platform processing device 102 and associated healthcare platform software 102a are included in a healthcare notification network as illustrated in FIG. 9 and described below in detail. In embodiments, system 100 may have far greater or fewer processing devices. In embodiments, a processing device may represent multiple hardware components or a network of distributed processing devices or hardware components. Processing devices may be coupled to Internet 103 by way of a wired or wireless connection, singly or in combination.

Healthcare website 101, in an embodiment, is a collection of healthcare related Web pages, images, videos or other digital healthcare related services that is hosted on one or more processing devices and is accessible via the Internet 103 by client processing devices. In an embodiment, a Web page is a digital document that may be written in HTML (Hypertext Markup Language) or an equivalent. The HTML document may be accessible via HTTP (Hypertext Transfer Protocol), a protocol that transfers information from a processing device to another processing device in response to a request. In an embodiment, one or more processing devices in system 100 include a HTML-compatible browser to view HTML Web pages. In an embodiment, HTML documents are provided from at least processing device 102 to processing devices 105a-b, 104a-b and 107 in response to a request. HTML provides basic document formatting and allows “links” to other processing devices (or servers) and files. A link such as a Uniform Resource Locator (“URL”) has a specific syntax that identifies a network path to a server for defining a network connection. Embedded hypertext links on a given Web page can be used to find information related to the given Web page. By clicking on a hypertext link in one Web page, the user can display another related Web page or even invoke a related software program.

In embodiments, a processing device may include a mainframe computer, server, laptop computer, hand-held computer, personal digital assistant, a facsimile machine, a telephone, a cellular telephone, a pager, short message service (SMS) messaging device, e-mail device, an information appliance, or an equivalent. In an embodiment, a processing device includes at least one integrated circuit processor that executes software.

In an embodiment, an organization may include a pharmaceutical company, medical device manufacturer, medical equipment manufacturer, government organization, or medical society; while healthcare providers may include physicians.

Healthcare website 101 (via healthcare platform processing device 102 and software 102a) provides a number of functions/services to content consumers, such as organizations and healthcare providers. In embodiments, healthcare website 101 provides the following services to content consumers:

1) Register, create and maintain a content consumer account with pertinent and up-to-date contact/profile information;

2) Real-time electronic notifications to selected healthcare providers regarding healthcare issues with a backup paper based system;

3) Self-managed repository of notifications for future reference;

4) Reference web site for access to healthcare information such as information related to product recalls and/or alerts, with robust search functionality;

5) Online provider of resources to obtain additional information on any product, ranging from informational brochures, videos, product samples; and

6) Portal which allows access for healthcare providers to connect to other healthcare providers in order to report adverse events, communicate warnings securely to patients and join or initiate discussions with other healthcare providers.

In embodiments, healthcare website 101 provides the following services to content providers, such as organizations:

1) Access to healthcare providers to disseminate critical healthcare notifications such as drug recalls or bioterrorism;

2) Tools to provide content, such as healthcare notifications, to selected healthcare providers; and

3) Access to reporting tools to monitor receipt of the healthcare notifications.

In an embodiment, healthcare platform processing device 102 has associated individuals or an organization that is charged with governing, enabling, supporting and providing other operational activities to the healthcare website 101.

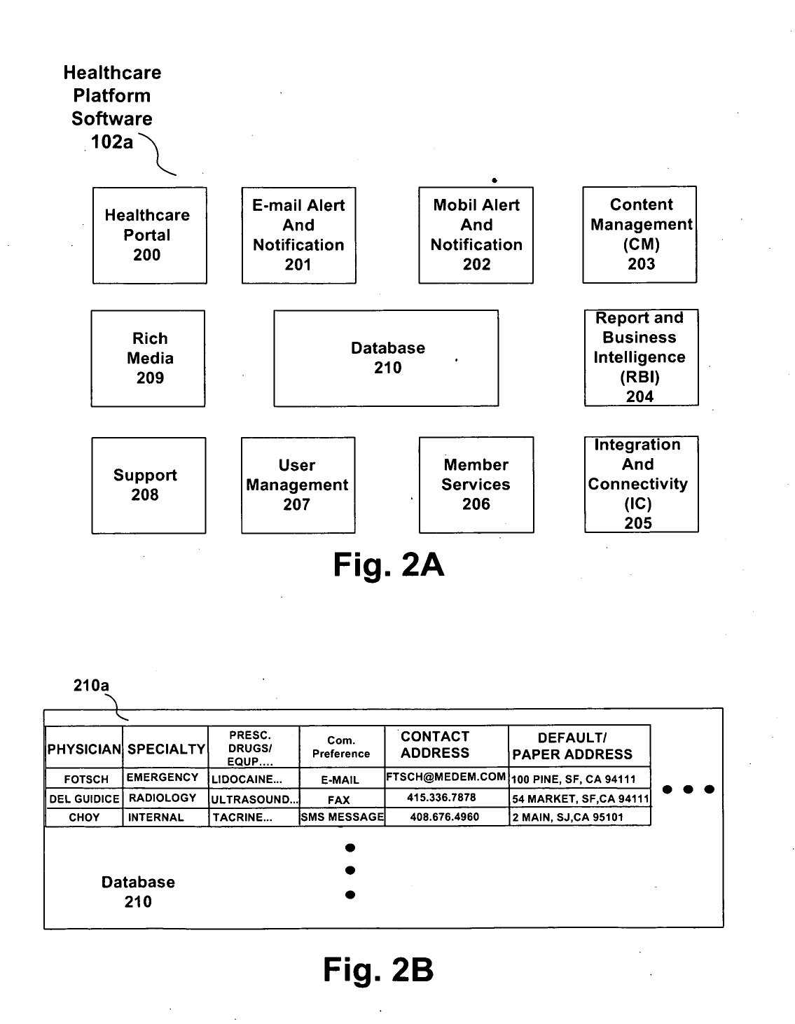

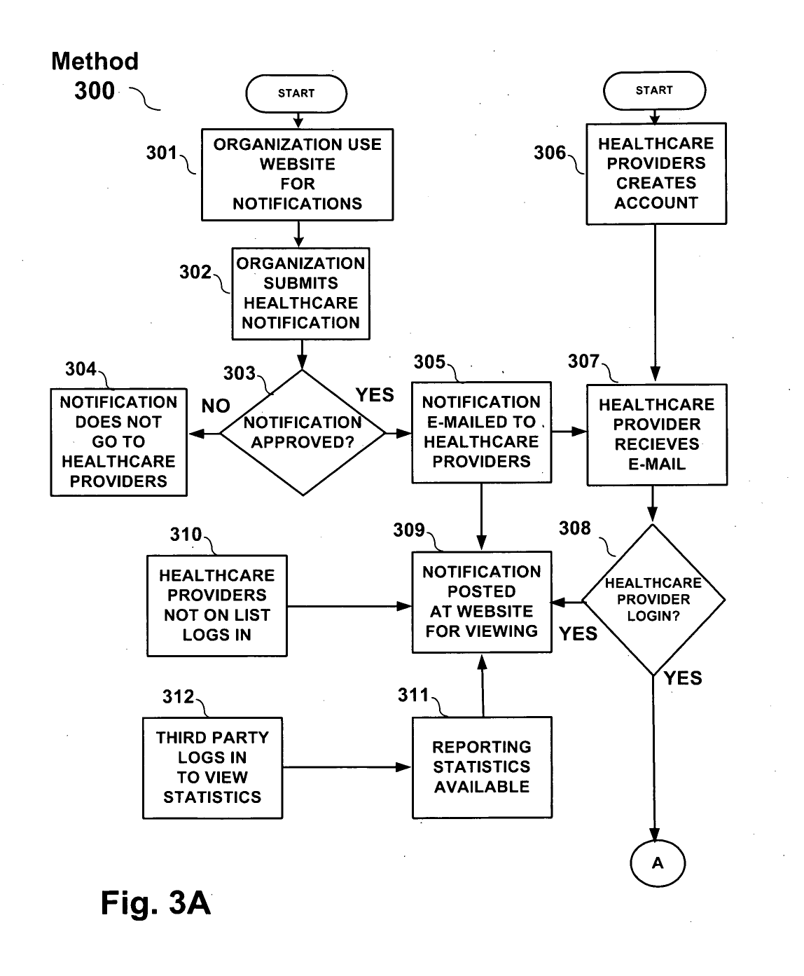

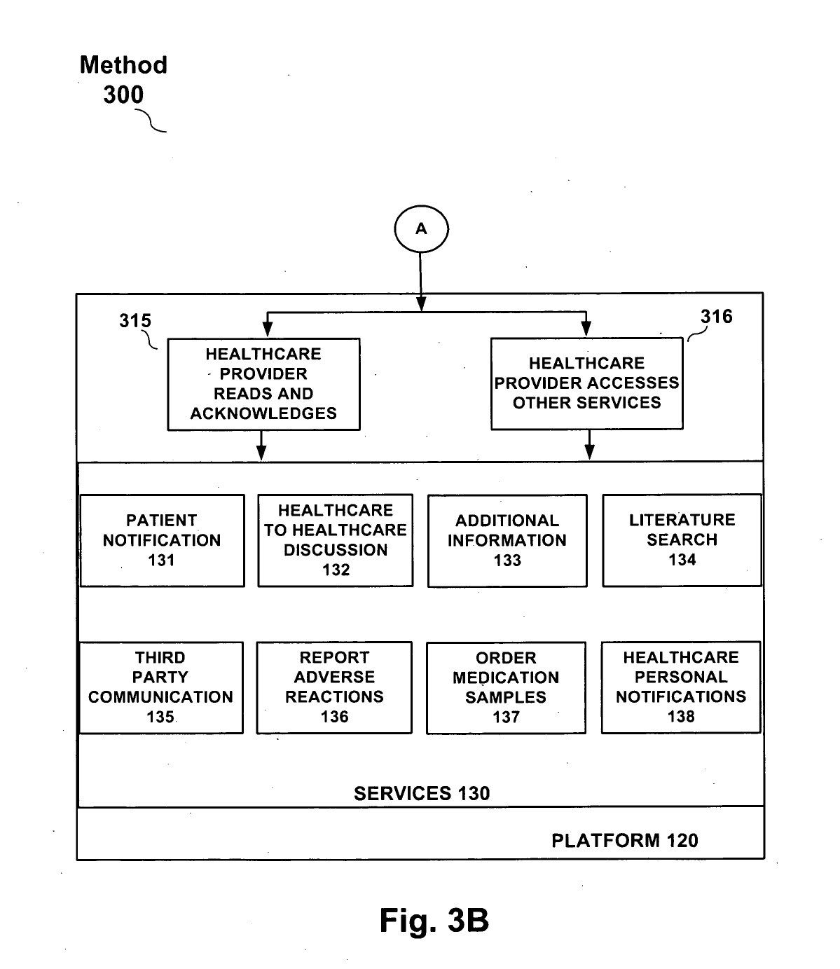

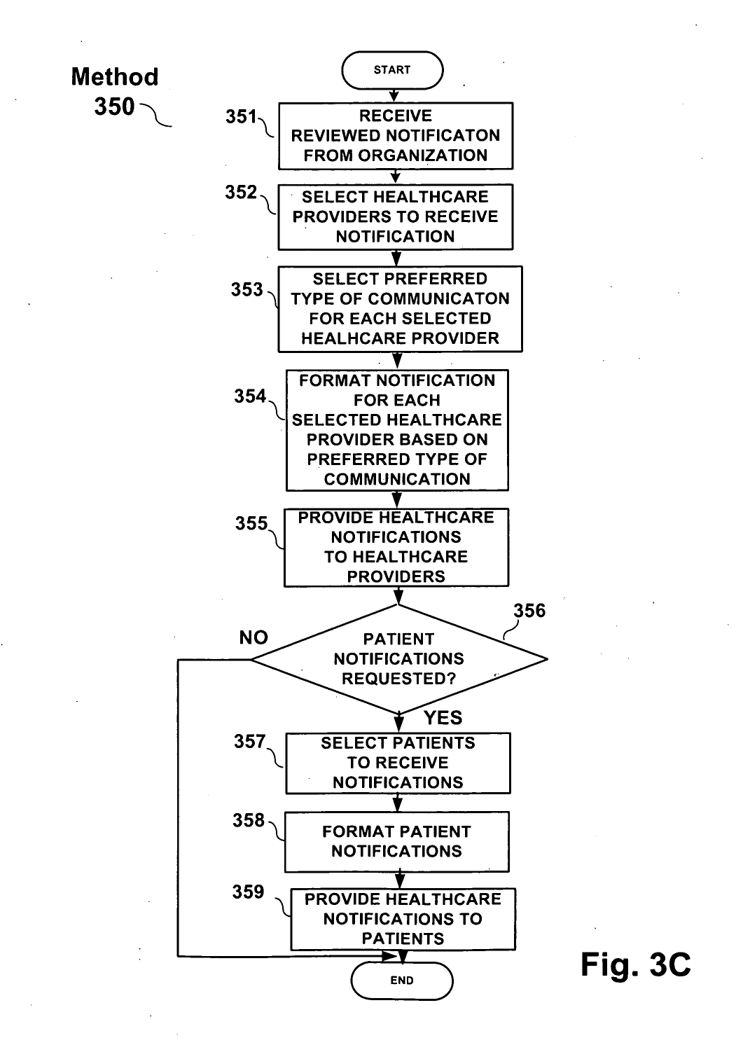

FIGS. 3A-C illustrate methods 300 and 350 according to embodiments. In an embodiment, FIGS. 3A-C illustrate the operation of system 100 shown in FIG. 1. As one of ordinary skill in the art would appreciate, FIGS. 3A-C illustrate logic boxes or steps for performing specific functions. In alternate embodiments, more or fewer logic blocks or steps are used. In an embodiment, a logic block or step may represent at least partial execution of a software component as well as execution of a hardware operation or user operation, singly or in combination. For example, many logic blocks in FIGS. 3A-C represent the execution of software components illustrated in FIG. 2A on processing device 102 shown in FIG. 1.

Logic block 306 illustrates a creation of a healthcare account at website 101. In an embodiment, individual healthcare providers create an account at website 101. In an embodiment, a healthcare organization, such as a medical society, health system, physicians group and/or an equivalent, pre-register their members as illustrated by logic block 306. The healthcare organization provides a data file to website 101 to create respective healthcare accounts. Website 101 then may generate respective e-mails to the members of the healthcare organization so that the members may complete the registration or healthcare account creation process.

Logic block 301 illustrates an organization, such as a pharmaceutical company, using system 100 to issue a healthcare related notification to healthcare providers having accounts, such as a recall of a drug used by anesthesiologists. A representative of the pharmaceutical company uses system 100 to submit a recall or health notification as illustrated by logic block 302. The representative specifies important parameters of the recall, data and other content associated with the recall, as well as criteria for recipients. The parameters associated with the recall also include the date/time of activation. The proposed notification is reviewed as illustrated by logic block 303. In an embodiment, a government agency or peer review board reviews the notification. If the notification is rejected, the notification is not sent as illustrated by logic block 304. In an embodiment, the rejected notification is sent back to the organization with an explanation of the rejection so that the third party may revise and resubmit another healthcare notification and logic blocks 301-303 may be repeated.

At the time of activation, as illustrated by logic block 309, healthcare system 100 makes recall data available to the selected group of content consumers which in this case includes anesthesiologists and possibly other specialists at healthcare website 101 for viewing.

At the same time, system 100 sends email to individuals within the group for whom it has email addresses as illustrated by logic block 305. Healthcare website 101 may also send FAXs to some of the healthcare providers, or messages to their mobile devices based on the communication preference of the respective healthcare providers. In other embodiments, a pager or other electronic means may be used. Healthcare website 101 resends notifications in the event of a delivery failure. Upon several successive failures, the website 101 would notify a content consumer via using standard mail. Some content consumers will have no means of electronic communication. In that case, a process of sending standard mail communication performed by a personnel supporting healthcare website 101 is triggered.

Logic block 307 illustrates a healthcare provider receiving an electronic message, such as an email, regarding a healthcare notification. Upon receipt of the electronic message, the healthcare provider may read detailed information or may log into the healthcare website 101 to view the full notification as illustrated in logic blocks 308 and 309.

Healthcare providers that did not receive an electronic message regarding a healthcare notification may also view the notification as illustrated by logic blocks 310 and 309.

Also, organizations may log into healthcare website 101 to view statistics, such as the number of healthcare providers that have received a particular healthcare notification as illustrated by logic blocks 311 and 312.

Logic block 315 illustrates that healthcare website 101 receives an acknowledgment that the selected healthcare provider has read the healthcare notification. The selected healthcare provider then may access other functions/services 130 at healthcare website 101 that may be related to the healthcare related notification. A healthcare provider may access services 130 that are not related to the healthcare notification as illustrated by separate logic block 316.

Logic blocks 131-138 shown in FIG. 3B represent a suite of services or functions provided at health care website 101. One of ordinary skill in the art understands that more or less services may be provided in embodiments.

Logic block 131 illustrates a service for a healthcare provider to transform the received healthcare notification to a notification for a patient or a selected subset of patients interested in the healthcare notification.

Logic block 132 illustrates a service for a healthcare provider to initiate or join a discussion with other healthcare providers regarding the healthcare notification or on another topic.

Logic block 133 illustrates a service for a healthcare provider to access additional information related or not related to the healthcare notification.

Logic block 134 illustrates a service for a healthcare provider to access a search program to obtain related literature or not related to the healthcare notification.

Logic block 135 illustrates a service for a healthcare provider to communicate with third parties, such as organization, regarding or not regarding the healthcare notification.

Logic block 136 illustrates a service for a healthcare provider to report adverse reactions to third parties.

Logic block 137 illustrates a service for a healthcare provider to order medication samples.

Logic block 138 illustrates a service for a healthcare provider to access previously received healthcare notification.

FIG. 3C illustrates a method 350 for providing healthcare notifications to selected healthcare providers based on their preferred mode of communication and then to patients of the healthcare providers. In an embodiment, healthcare website 101 provides healthcare notifications to selected healthcare providers. In an embodiment, method 350 represents an embodiment represented by at least logic blocks 305-309 and 131 shown in FIG. 3C.

Method 350 begins by receiving a reviewed healthcare notification from an organization as illustrated by logic block 351. In an embodiment, the healthcare notification has been reviewed and approved by a reviewing entity. Healthcare providers to receive the notification are selected as illustrated by logic block 352. Healthcare providers to receive the notification may be selected based on a number of criteria that may be stored in a database, such as database 210 shown in FIG. 2. Healthcare providers may be selected based on their specialty or recently entered or prescribed drugs. Similarly, healthcare providers may be selected based on entered or used medical equipment or medical devices. Also, healthcare providers may be selected based on their entries to a database or answers to queries regarding healthcare notifications.

Logic block 353 illustrates selecting the preferred mode of communication for providing the healthcare notification to the selected healthcare providers. A preferred mode of communication may be email, regular mail, pager, fax, text message or other modes of communication. In an embodiment, healthcare providers enter the preferred mode of communication and profile/contact information at healthcare website 101. In an embodiment, the preferred mode of communication and profile/contact information are obtained from a healthcare provider record stored in database 210.

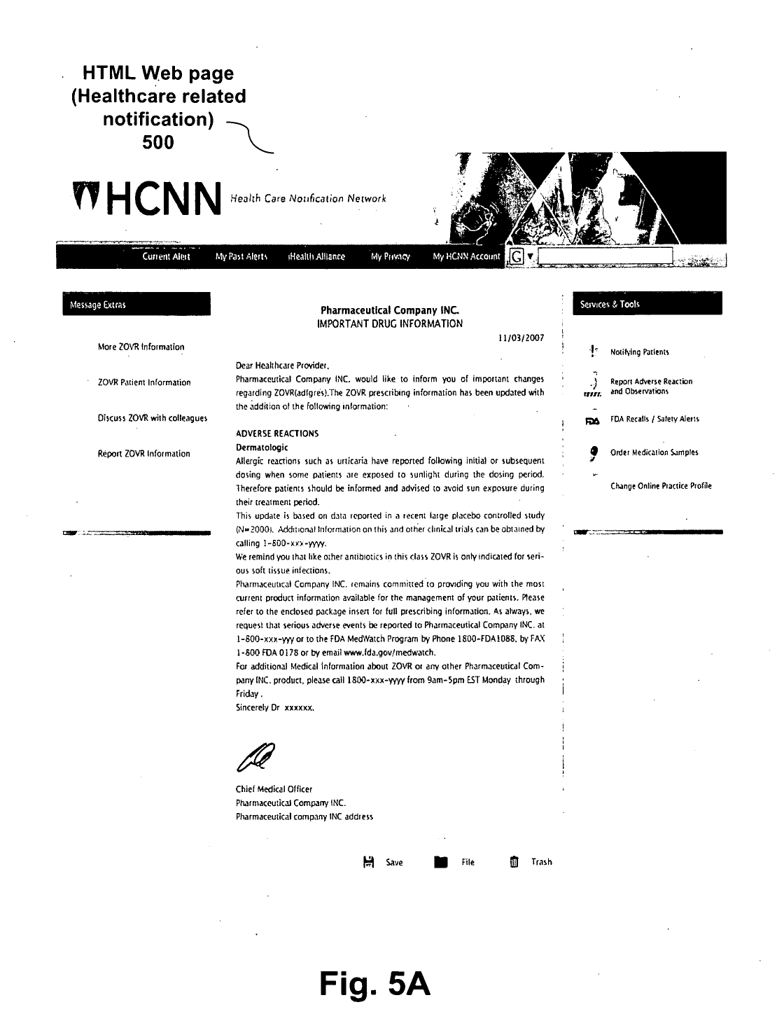

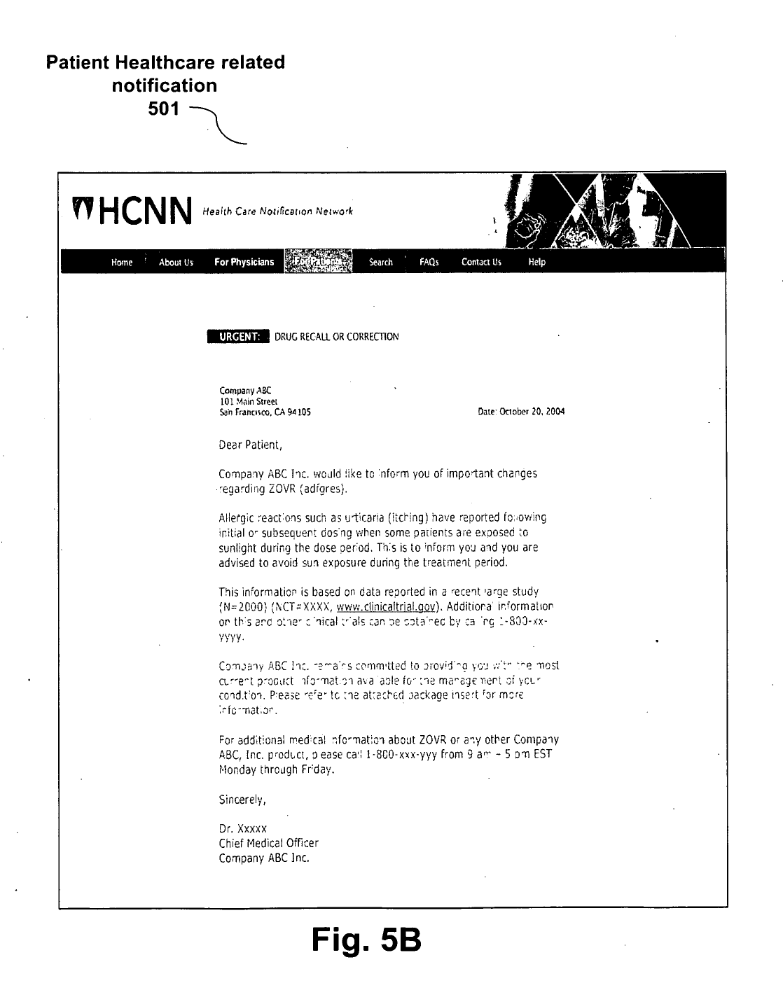

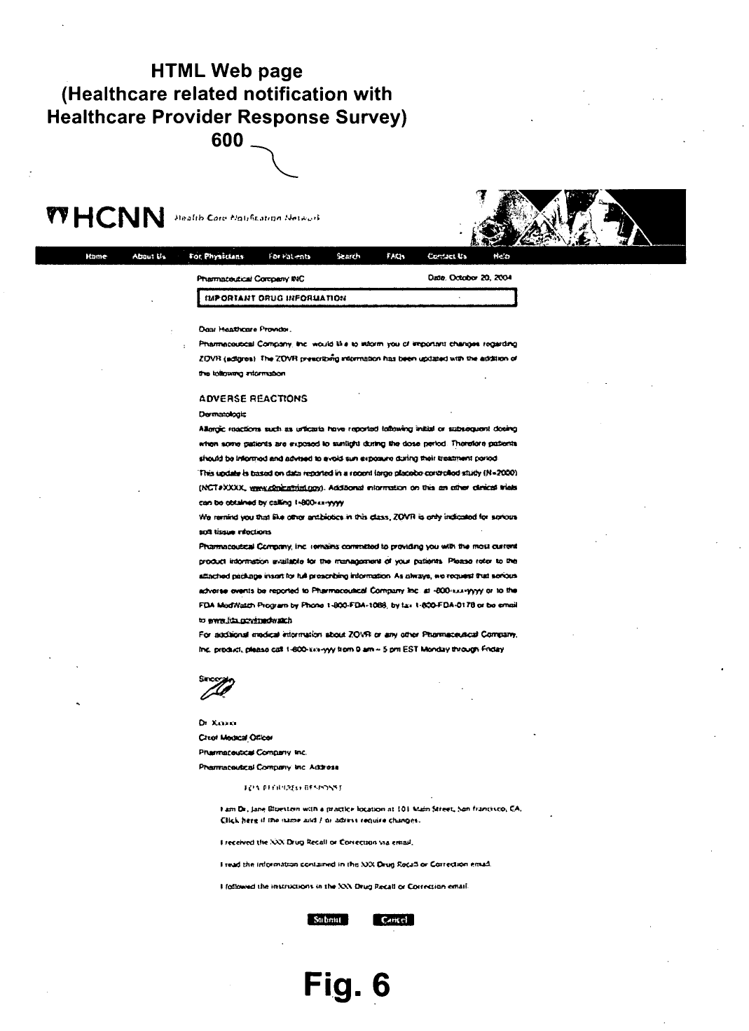

The healthcare notification is then formatted based on the preferred mode of communication and generated to the selected healthcare provider as illustrated in logic blocks 354 and 355. In an embodiment, an email message with a link or URL address to a healthcare notification in a Web page at healthcare website 101 is provided to the selected healthcare provider. In embodiments, web pages 500 and 600 as illustrated in FIGS. 5A and 6 are provided. Web page 500 illustrates a notification regarding an allergic reaction of the drug “ZOVR” under certain conditions from a pharmaceutical company Inc. Web page 600 illustrates a similar notification with a “FDA REQUIRED RESPONSE” or survey questions that may be answered and transferred back to healthcare website 101.

In an embodiment, healthcare providers may register for pre-alerts or pre-healthcare related notifications. When system 100 becomes aware that a healthcare notification will be generated shortly, a healthcare provider may receive a pre-alert notice, such as “Healthcare Notification coming tomorrow.” These Pre-Alerts or pre-healthcare notifications may be generated to partners, such as medical societies, a day in advance of the healthcare notification. A partner pre-alert may contain both a message to “look for the Alert via the Healthcare Website 101” if the healthcare provider is registered and/or a “register on the Healthcare Website 101 to receive the alert tomorrow” message.

In embodiments, alerts and/or healthcare notifications include a viral marketing message, such as “tell a colleague.” In an embodiment, system 100 provides a chat area, as illustrated by logic block 132, where notification recipients can discuss a healthcare notification with colleagues who also received the notification. Similarly, the notification recipient may report adverse reactions or communicate with third parties as illustrated by logic blocks 135 and 136.

A determination, as represented by logic block 356, is made whether the healthcare provider would like to forward a patient version of the healthcare notification to selected patients or all of the healthcare provider patients. When patient notifications are not requested, method 350 ends. Otherwise, control transfers to logic block 357 where patients to receive the patient formatted healthcare notification are selected. In an embodiment, patients may be selected based on previously prescribed medications, health conditions, age or other factors that may be stored in an electronic patient health record in database 210 associated with the healthcare provider.

Patient notifications are then formatted as illustrated by logic block 358 and generated to selected patients as illustrated by logic block 359. In an embodiment, patient healthcare related notification 501, shown in FIG. 5B, is a patient version (or format) of the information in web page 501 that was provided to the healthcare provider (or the healthcare provider's organization-Company ABC Inc.) of the patient. In an embodiment, patient notifications may be emailed. Method 350 then ends.

III. Software Architecture

FIG. 2A illustrates software components of software 102a that may be executed on healthcare platform processing device 102, shown in FIG. 1, to provide healthcare website 101 including other healthcare related services. In an embodiment, healthcare platform software 102a includes machine/computer readable or executable instructions. In an embodiment, software 102a is stored in an article of manufacture, such as a computer readable medium that may be removable from or included in a processing device. For example, software 102 may be stored in a magnetic hard disk, an optical disk, a floppy disk, CD-ROM (Compact Disk Read-Only Memory) as illustrated in FIG. 1, RAM (Random Access Memory), ROM (Read-Only Memory), EEPROM (Electrically Erasable Programmable Read-Only Memory) or other readable or writeable data storage technologies, singly or in combination. In alternate embodiments, software 102a may be transferred by an electronic signal or downloaded by way of the Internet using wired and/or wireless connections.

In embodiments, FIG. 2A illustrates software components that may include a software program, software object, software function, software subroutine, software method, software instance or a code fragment, singly or in combination. In embodiments, software components illustrated in FIG. 2A have functions described in detail below.

A. Healthcare Portal 200

Healthcare portal 200 provides content consumers with access to medical event information that includes medication recalls and warnings, medical device recalls and warnings, medical equipment recalls and warnings. In particular, Healthcare portal 200 displays 1) most recent recall and warning information for medicines, medical devices and medical equipment; 2) most viewed recall and warning information; 3) specific recall data and ancillary materials including reach media data (from rich media 209 described below) such as photos and video and or suggested communications to patients; and 4) search and list data via various combinations of search criteria. For example, a user will be able to enter various search criteria, such as manufacturer name, type of recall, product name, etc., to obtain a healthcare notification from an internal search software component.

Healthcare portal 200 also provides content consumers with: 1) access to healthcare news and publications; 2) connectivity to selected content providers, such as pharmaceutical companies, manufacturers, and government organization such as the FDA (in an embodiment IC 205 described below is used to provide this service); 3) a report function of adverse reaction to a medicine; 4) order drug samples; 5) order brochures; 6) access to maintenance functions such as maintaining healthcare provider profiles/contact information; 7) access to targeted search of information within the portal and through external search engines; and 8) connectivity to external applications, such as secure messaging communication with healthcare providers, social networks related or dedicated to healthcare content and discussion forums dedicated or related to healthcare content (in an embodiment IC 205 described below is used to provide this service).

B. Email and Mobile Alert and Notification 201/202

Email and Mobile Alert and Notification 201/202 provides content consumers with real time notifications associated with release of healthcare related information, such as medication recalls and warnings, medical device recalls and warnings, and medical equipment recalls and warnings.

In embodiments, notifications may be delivered to predetermined healthcare providers via a variety of electronic mediums, such as emails, facsimile, SMS messages, IM messages, pager calls or an equivalent. The electronic notifications may be sent at a predetermined time as selected by the organization or a specific end user.

In embodiments, notifications may contain detailed information, brief information or just a pointer (or link) to information which can be accessed via healthcare website 101.

C. Content Management 203

Content Management (CM) 203 provides content contributors with ability to publish content associated with release of healthcare notifications, such as medication recalls and warnings, medical device recalls and warnings, and medical equipment recalls and warnings.

CM 203 also enables monitoring appropriate use of healthcare website 101 by content providers.

D. Reporting and Business Intelligence 204

Reporting and Business Intelligence (RBI) 204 provides content providers with a variety of data associated with release and receipt of healthcare information, such as medication recalls and warnings, medical device recalls and warnings, and medical equipment recalls and warnings. In an embodiment, RBI 204 provides a report to organizations of healthcare providers who have received notifications and answers to survey questions.

Reports provided by RBI 204 are delivered based on roles and data access rules maintained by user management 207 described below.

E. Integration and Connectivity 205

Integration and Connectivity (IC) 205 provide external parties with connectivity to healthcare website 101. Connectivity to external parties is bidirectional, meaning that external parties can submit and retrieve data from healthcare website 101. Both submission and retrieval of the data is controlled through multilayer security ensuring that only authorized parties can access information.

F. Member Services 206

Member Services 206 enables healthcare website 101 support and customer service staff to perform operations that require accessing or altering data. In particular, Member Services 206 is used to provide minor technical support to the content providers and content consumers, such as restoring lost passwords and user IDs.

G. User Management 207

User Management 207 stores information associated with content consumers and content providers as well as the associated permissions, roles and access rights.

H. Support 208

Support 208 maintains a safe and secure operation of healthcare website 101. With security, privacy and safety being complex multi-fold objectives, Support 208 includes a number of software components serving multiple objectives: logging and auditing, internal alert and notification, performance and availability control.

I. Rich Media 209

Rich Media 209 stores and provides photos, audio, large documents and video and/or suggested communications to patients in regard to healthcare notifications.

J. Centralized Database 210

Central database 210 stores and maintains information such as recall data, notification information and application metadata or information that describes the composition and architecture of data. For example, metadata may include a data dictionary. Most software components illustrated in FIG. 2A access central database 210.

FIG. 2B illustrates healthcare provider profiles 210a that includes a plurality of healthcare provider profiles and preferred electronic notification contact information. FIG. 2B illustrates a portion of a data structure stored in database 210 and one of ordinary skill in the art understands that database 210 includes other data as well. Healthcare provider profile 210a includes fields of information associated with each healthcare provider name or physician. In particular, each physician name has an associated 1) medical specialty; 2) typically prescribed or currently prescribed drugs and typically used equipment or currently used equipment; 3) preferred type of electronic notification; 4) contact address; and 5) default or address that the notification may be mailed. One of ordinary skill in the art also understands that healthcare provider profiles 210a may include more or less fields of information depending upon a particular embodiment.

In an embodiment, CM 203 software component accesses healthcare provider profiles 210a to select which healthcare provider will receive a healthcare related electronic notification in response to healthcare notification from an organization, such as a drug manufacturer. In an embodiment, user management 207 and CM 203 software components accesses healthcare provider profiles 210a to determine how and where the electronic notification will be sent to the selected healthcare provider. For example, if an ultrasound manufacturer provided a recall of a particular ultrasound device to healthcare website 101, Dr. Del Guidice would receive a facsimile notification while Drs. Fotsch and Choy would not receive a notification because they do not work with ultrasound equipment. Similarly, Dr Fotsch would receive an email notification of a recall of the drug lidocaine; while Drs. Del Guidice and Choy would not as their specialty and typically prescribed drugs indicate that they do not typically prescribe lidocaine.

In an embodiment, database 210 includes a plurality of patient electronic health records associated with each physician. Each patient electronic health record includes information, such as prescribed drugs, medical conditions/allergies, age, etc., that allow healthcare website 101 to identify patients to receive particular healthcare notifications.

IV. Hardware Architecture

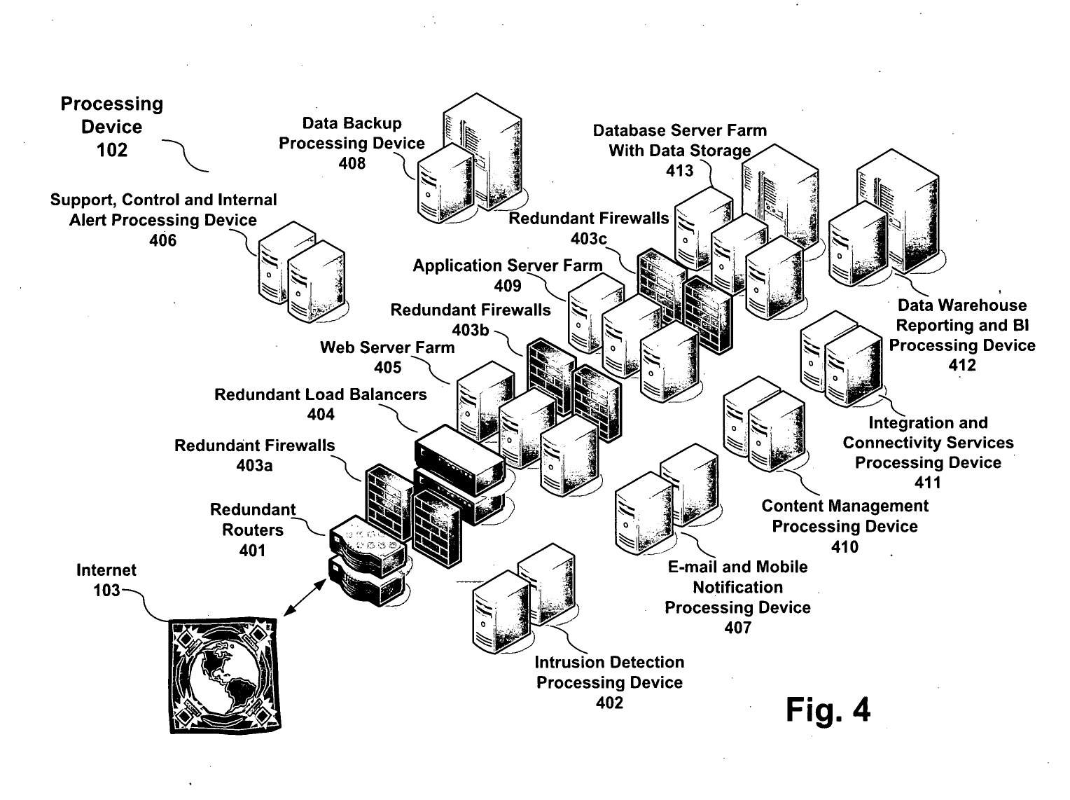

FIG. 4 illustrates a hardware architecture embodiment of processing device 102 shown in FIG. 1.

Processing device 102 and software 102a operate under an Application Service Provider (ASP) model. Software is delivered from processing device 102 as services rather than a set of deliverables (s/w packages, executables, CDs, etc.) to processing devices 105a-b,104a-b and 107 via Internet 103. Software offered using an ASP model may be called On-demand software or Software as a Service (SaaS). For example, access to an application program, such as Healthcare Portal software component 200 shown in FIG. 2A, using a standard protocol such as HTTP is provided by processing device 102. Applications are accessed by content consumers and content providers through a web browser on their respective processing devices using HTML or by special purpose client software which access interfaces exposed by processing device 102.

In embodiments, processing device 102 includes a large number of servers, networking equipment, other processing devices, sub-systems and/or equivalent hardware, designed to support uninterrupted functioning of software components and services. As one of ordinary skill in the art would appreciate, more or less processing devices shown in FIG. 4 may be used in alternate embodiments. In embodiments, one or more software components illustrated in FIG. 2A are at least partially stored and/or at least partially executed by processing devices illustrated in FIG. 4. In alternate embodiments, processing devices illustrated in FIG. 4 may be replaced by functionally equivalent software components.

Redundant routers 401 are coupled to Internet 103 and are responsible for routing messages, such as IP packets, between Internet 103 and the rest of processing device 102 or the local area network of processing devices illustrated as processing device 102 in an embodiment.

Redundant firewall 403a, coupled to redundant router 401, is responsible for, along with intrusion detection processing device 402, detecting unauthorized users (such as hackers and intruders) and preventing unauthorized users from accessing processing device 102.

Redundant firewalls 403b and 403c coupled to web server farm 405, application server farm 409 and database server farm with data storage 413 also are responsible for preventing unauthorized users from accessing processing device 102 and in particular application server farm 409 and database server farm with data storage 413.

Redundant load balancers 404, coupled to redundant firewall 403a, are responsible for providing a single Internet service from multiple servers and spread work among the multiple servers.

Support, Control and Internal Alert processing device 406 is responsible for controlling, reporting, auditing and notifications associated with processing device 102. In an embodiment, Support Control and Internal Alert processing device 406 is used to support and maintain availability of processing device 102. In an embodiment, support software component 208 is at least partially stored and/or executed by processing device 406.

Web server farm 405 includes a plurality of processing devices that accept HTTP requests from Internet 103 from healthcare providers and organizations as well as providing HTTP responses that may include data (such as HTML web pages/documents) to the healthcare providers and organizations. Web server farm 405 accesses other processing devices that may provide information and services. For example, Web server farm 405 may access email and mobile notification processing device 407 to generate an email healthcare notification to a particular set of healthcare providers stored in database server farm with data storage 413.

Email and mobile notification processing device 407 is responsible for generating email and mobile healthcare notifications to selected healthcare providers. Software components 201 and 202 are at least partially stored and/or executed by processing device 407.

Application server farm 409 includes a plurality of processing devices, coupled to redundant firewall 403b, that are responsible for delivering applications/services to processing devices coupled to Internet 103 using HTTP. Application server farm 409 is responsible for dynamic content and accessing database server farm with data storage 413. In an embodiment, healthcare portal 200 is at least partially stored and/or executed by application server farm 409.

Content Management processing device 410 is responsible for creating and maintaining of the content such as publishing, editorial workflow, as well as definition of target distribution criteria. In an embodiment, content management software component 204 is at least partially stored and/or executed by processing device 410.

Integration and connectivity services processing device 411 is responsible for integration with a variety of third party systems. Integration includes both publishing and subscription activities supporting two-way flow of the data. In an embodiment, IC software component 205 is at least partially stored and/or executed on processing device 411,

Database server farm with data storage 413 includes a plurality of processing devices, coupled to redundant firewall 403c, that are responsible for accessing database software component 210 and rich media software component 209. In an embodiment, database server farm with data storage 413 accesses selected healthcare providers based on the content of healthcare related notifications provided by organizations and the healthcare provider profile. This selected list of healthcare providers along with associated electronic addresses are then passed to email and mobile notification processing device 407 to generate the appropriate notices to the appropriate electronic addresses.

Data warehouse reporting and BI processing device 412 is responsible for tracking and storing statistics, such as the number of acknowledgements and which healthcare providers had received healthcare related notifications and/or provided answers to survey questions. Organizations may access these statistics.

Data backup processing device 408 backs up or provides a duplicate of data and transactions performed in processing device 102.

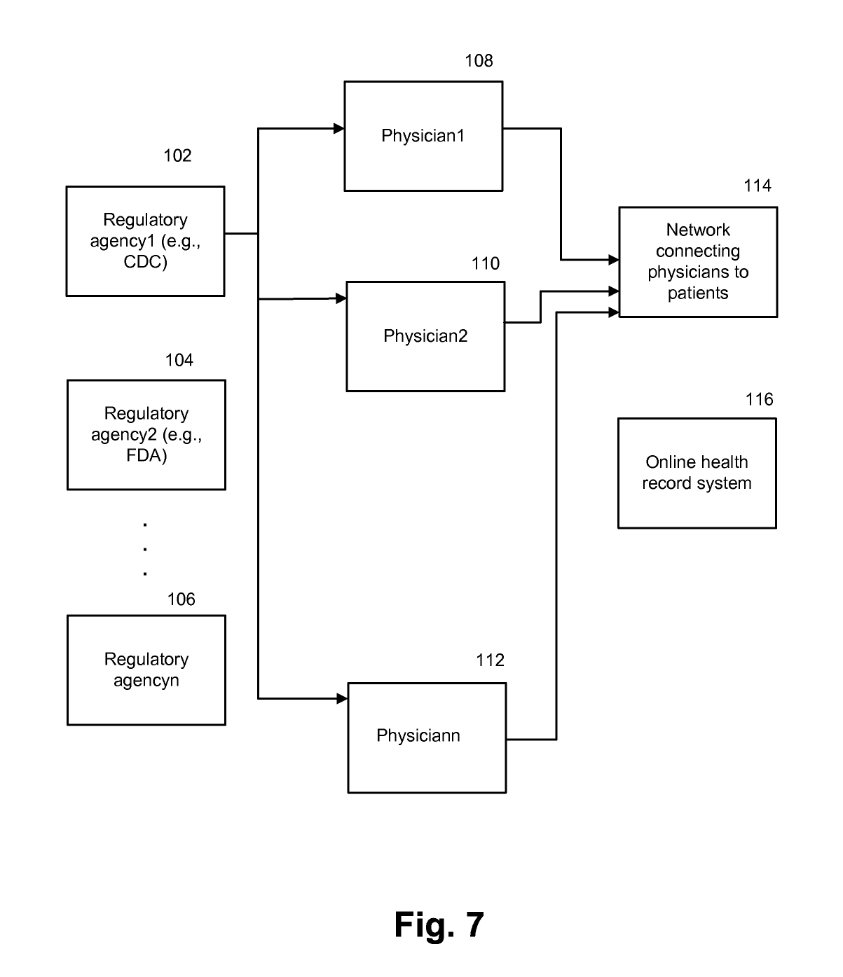

FIG. 7 is a system diagram illustrating a system in which another embodiment may be implemented. Specifically, the system enables organizations to communicate with healthcare providers regarding health-related issues affecting patient health. The organizations may include any organizations with a need to communicate with healthcare providers (e.g., physicians) on a local, regional or national level regarding health-related issues affecting patient health, such as the CDC or FDA. The health-related issue may, for example, pertain to issues such as those related to a product (e.g. product recall), food, medical device, or a drug (e.g., drug recall or correction, such as a label change), an epidemic, or bio-terrorism alert. Other examples may include newly discovered information about a medication such as drug interactions, use of the drug with patients with various medical disorders, or modifications to the proper dosage and administration of the drug.

In this example, a healthcare notification network enables communication on behalf of organizations such as regulatory agencies 102, 104, 106 to healthcare providers such as physicians 108, 110, 112. This may be accomplished, for example, through registration of the organizations and physicians with the network. In this manner, regulatory agencies such as the FDA or the CDC may communicate with healthcare providers such as physicians.

While it is possible that email may be used to support communication between the regulatory agencies 102, 104, 106 and the healthcare providers 108, 110, 112, there is currently no national professional healthcare email network. Through the use of a healthcare notification network, healthcare providers may access communications from these agencies. Similarly, the agencies may also receive responses from the healthcare providers, via the network, in response to the notifications. These communications may be secured (e.g., via username and password) or unsecured. The healthcare notification network enables notifications to be composed and delivered to physicians via email, as well as acknowledgements to be delivered back to the network, and then on to the organizations in response to the notifications, as will be described in further detail below.

In the example shown in FIG. 7, the regulatory agency 102 (e.g., CDC) sends an electronic notification for a particular health-related issue to the network, for distribution to one or more healthcare providers. The electronic notification may also include a mechanism for obtaining an acknowledgement indicating, at minimum, that the healthcare provider has received and opened the electronic notification. In this manner, the regulatory agency 102 may receive information from the network regarding an acknowledgement from the healthcare provider indicating that the healthcare provider has received and opened the electronic notification. The acknowledgement may also indicate that the healthcare provider has read the electronic notification, as well as indicate that the healthcare provider has followed or agrees to follow the instructions in the notification and/or that the healthcare provider has notified or will notify patients affected by the health-related issue. Other organizations 104, 106 (e.g., companies or regulatory agencies) may transmit or have electronic notifications transmitted and receive acknowledgements in a similar manner. From the acknowledgements (or reports thereon), the organizations 102, 104, 106 may compile the appropriate reports in compliance with FDA and CDC regulations.

Once a healthcare provider (e.g., physician) has been notified of a particular health-related issue, they should notify the appropriate patients. This may be accomplished, for example, by notifying the patients via a network 114 connecting the physician(s) to their patients. In other words, the network 114 may be a network to which the healthcare provider and their patients belong. This notification may be a new notification message that is automatically generated or manually composed by the healthcare provider. Alternatively, the healthcare provider may choose to forward the notification received by the healthcare provider to the affected patients, when an organization has given the physician a notification that is appropriate for distribution to patients. The network 114 may be a part of the network that enables communication between the organizations and the healthcare providers or, alternatively, the network 114 may be a separate network connecting the healthcare providers to their patients. One such network connecting healthcare providers with patients is described in further detail in Attorney Docket No. MDMPP001, patent application Ser. No. 10/387,041, entitled “HEALTHCARE PROVIDER-PATIENT ONLINE CONSULTATION SYSTEM,” filed on Mar. 10, 2003, naming Fotsch et al as inventors, which is incorporated herein by reference for all purposes. Through this network, secure and confidential communications between healthcare providers and patients is supported (e.g., via registration and login using a username/user ID and password).

The healthcare provider may send an appropriate notification message to all of his or her patients. Alternatively, the healthcare provider may identify the patients affected by the particular health-related issue identified in the notification message received by the healthcare provider. In order to identify the affected patients, the healthcare provider may search an online health record system 116 storing health records for a plurality of patients to identify the subset of his or her patients affected by the particular health-related issue. For instance, the healthcare provider may search the online health record system 116 for patients affected by a particular medical condition and/or taking a particular medication. An exemplary online health record system is described in further detail in Attorney Docket No. MDMPP002, patent application Ser. No. 11/085,984, entitled “ELECTRONIC PERSONAL HEALTH RECORD SYSTEM,” filed on Mar. 21, 2005, naming Fotsch et al as inventors. In this manner, a healthcare provider may identify a segment of their patients affected by the health-related issue identified in a notification received from an organization such as the FDA or the CDC.

The electronic notification may be implemented in a variety of forms, and in accordance with a variety of formats and protocols. For instance, the electronic notification may be sent in the form of an electronic mail message. The electronic notification (e.g., electronic mail message) may also include a link to a web page that includes at least a part of the content of the electronic notification. The electronic mail message containing the notification can be sent to a computer email system, a pager, a cell phone, or other device, or some combination of the above, that will enable immediate access to the information by the healthcare provider.

Similarly, the acknowledgement may be transmitted by a healthcare provider to the network or organization that transmitted the electronic notification in a variety of forms, and in accordance with a variety of formats and protocols. For instance, the acknowledgement may be sent in the form of an electronic mail, or may be submitted via a web site such as that referenced in the link from the electronic notification.

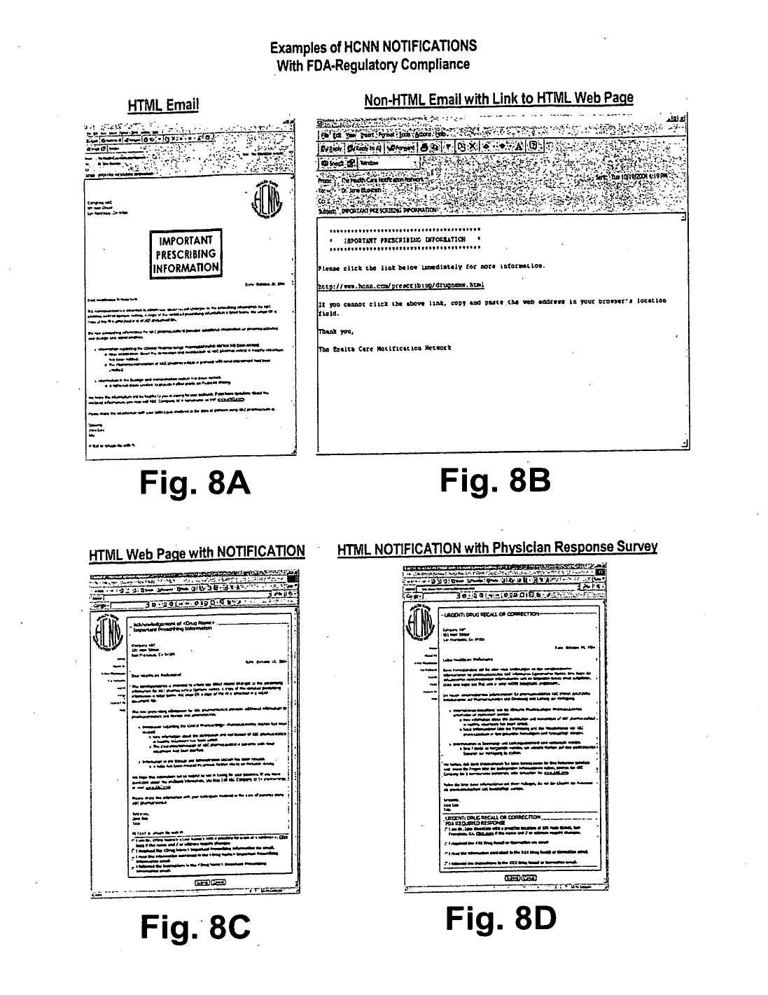

It is also important to note that the acknowledgement may also be sent automatically to the network or organization in the form of an automated response, as well as in response to input by the healthcare provider. For instance, an automated response may be implemented via a HTML tag, as will be described in further detail below. This is particularly useful, for example, in notifying the network, and then the organization, that the healthcare provider has received and opened the corresponding notification, since the healthcare provider may not be required to respond to a particular notification, or forget to respond to the notification. FIGS. 8A-D present exemplary mechanisms for transmitting a notification to a healthcare provider, as well as exemplary mechanisms for obtaining an acknowledgement from the healthcare provider.

It is important to note that, while conventional email systems may be used to transmit notifications, FDA regulations currently require that notifications sent to physicians use specific font sizes and colors. In order to fulfill such requirements, in accordance with one embodiment, HTML-type viewing of the notification is supported. This may be accomplished via a HTML email or an email with a link to a HTML web page.

In accordance with various embodiments, a notification email may be sent in HTML format, as well as non-HTML format. FIG. 8A is an exemplary HTML email including a notification that may be transmitted to healthcare providers. This exemplary email pertains to prescribing information. Specifically, in this example, new information about the distribution and metabolism of the identified drug is provided. In addition, the effect of the medication on patients with renal impairment is clarified, and information regarding the dosage and administration of the drug is clarified with respect to pediatric dosing.

In accordance with one embodiment, if the recipient has a HTML-capable email application, the HTML email will be opened and a HTML tag in the HTML email will report receipt back to the healthcare notification network, thereby supporting automated acknowledgement in response to the notification. In some embodiments or if the recipient's email application is not HTML-capable, the recipient receives a simple message (in HTML or non-HTML format) that an important patient safety message is available through a hypertext link embedded in the email. The recipient then clicks on the link and is taken to a HTML web page. At that time, a HTML tag may be reported to the healthcare notification network. In accordance with one embodiment, the HTML tag will carry the information necessary to accurately identify the healthcare provider.

As set forth above, rather than providing the relevant information in the email itself, the information (or portion thereof) may be provided in a separate web page. FIG. 8B is an exemplary non-HTML email with a link to a HTML web page including a notification that may be transmitted to healthcare providers. In this example, the notification is not provided in the email, but in the web page. Thus, the user must access the web page referenced in the email to read the notification.

As set forth above, a HTML notification may be provided in the form of a link to a HTML web page or HTML email. FIG. 8C is an exemplary HTML web page with notification and physician response survey that may be transmitted to healthcare providers, while FIG. 8D is an exemplary HTML notification with a physician response survey that may be transmitted to healthcare providers.

As shown in both FIGS. 8C and 8D, the notification may include a mechanism for obtaining an acknowledgement, which may be in the form of a physician response survey (as shown). The physician response survey may be accessed when the user accesses the web page (as shown), or alternatively, may be accessed when the user reads the electronic notification (e.g., email). The physician response survey includes one or more questions or entries requiring a response by the healthcare provider.

In this example, the physician response survey enables a healthcare provider to confirm his or her identity, as well as submit any name or address changes. Moreover, the healthcare provider may indicate that he or she has followed or will follow the instructions provided in the electronic notification (as shown), or more specifically, the healthcare provider may indicate that he or she has notified or will notify patients affected by the health-related issue.

The above-described embodiments may be used to notify healthcare providers (e.g., physicians) of issues affecting patient health. Thus, the notifications and content thereof may comply with FDA and/or CDC regulations. For instance, FDA regulations may be found in the ORA/Office of Enforcement, Division of Compliance Management and Operations Guidance for Industry, Product Recalls, including Removals and Corrections, which may be found at HTTP://www.fda.gov/ora/compliance_ref/recalls/ggp_recall.htm, which is incorporated herein by reference. In accordance with such regulations, information may include a description or identification of the product that is the subject of the notification. The description or identifying information may include information such as the identity of the manufacturer, as well as the identity of the recalling firm (e.g., manufacturer, importer, broker, repacker, or own-label distributor). The information provided in the notification may also include the identity of the firm responsible for the violation or problem, as well as the reason for the recall or notification. Furthermore, the notification may also include a health hazard assessment including an assessment of the health risk. Finally, the notification may provide instructions to the patients, such as returning the product, discontinued use of the product, or modification of dosage or other instructions for modified use of the product in accordance with the notification.

FIG. 9 is a block diagram of a hardware environment in which the various embodiments of the healthcare notification network may be implemented in order to facilitate communication between organizations and healthcare providers. The healthcare notification network through which communications between organizations and one or more physicians are facilitated according to an embodiment and the network itself through which these notifications are sent may be include a server 2002, which is connected by a router 2004 to the Internet 2006. Employees of the network at computers 2003 may be coupled to the server 2002 to receive communications from organizations. Once the employees review the communications and deemed them appropriate for transmission, they may transmit them to healthcare providers by the router 2004 via the Internet 2006.

In addition, physician office computers 2008 may also be connected to the Internet via routers 2010 in order to receive the transmission of emails from the server 2002 and transmit acknowledgement messages to the server 2002 (e.g., via answering a survey or automatically). The physician office computers 2008 may run software as well as store messages such as notification messages received by the physicians. Physician office computers 2008 may have networks 2012 associated therewith interconnecting a plurality of personal computers or work stations 2014. In this manner, an office network may access received emails from the email client through the server 2002. Organizations (e.g., agencies) (represented by computers 2022 and 2024) may be connected to the Internet in a variety of ways for transmission of messages to the network. For example, an agency worker employed by an agency may be connected from his home via a modem 2026, or from his workplace via a network 2020, a file server 2016, and a router 2018. It will be understood that, according to various embodiments of the invention, employees of such organizations or agencies may gain access to the Internet for transmission of information to the network and then on to the healthcare provider via a variety of hardware configurations. Similarly, such employees may be coupled to a web site on server 2002 in order to gain access to the server 2002 and to initiate the transmission of communications such as email notifications to the network, for distribution to one or more physicians. Similarly, an employee may access the network 2002 or web site from his computer 2014 at his place of employment. It will also be understood that the hardware environment of FIG. 9 is shown for illustrative purposes and that a wide variety of hardware environments may be employed to implement the various embodiments of the present invention. It should also be understood that specific embodiments of the methods and processes described herein may be implemented as computer program instructions, i.e., software, in the memory of the computers and servers.

Although illustrative embodiments are shown and described herein, many variations and modifications are possible which remain within the concept, scope, and spirit of the claims, and these variations would become clear to those of ordinary skill in the art after perusal of this application. For instance, an embodiment is based upon the generation and transmission of notification messages via email and/or web site. However, it should be understood that embodiments are not limited to this arrangement, but instead would equally apply regardless of the mode of transmission or system configuration, including the use of pagers, cell phones, or other instruments as receiving devices for the notifications. Accordingly, the present embodiments are to be considered as illustrative and not restrictive, and the invention is not to be limited to the details given herein, but may be modified within the scope and equivalents of the appended claims.

What is claimed is:

1. A method of operating a processing device that provides a website used to send an electronic healthcare notification to a plurality of health providers from an organization, the method comprising:
receiving information regarding the healthcare notification from an organization;
generating the electronic healthcare notification in a predetermined format to a selected healthcare provider in the plurality of healthcare providers; and
receiving an acknowledgement of receipt of the electronic healthcare notification from the selected healthcare provider.

2. The method of claim 1, further comprising:
receiving an alert that the information regarding the healthcare notification will be available;
reformatting the electronic healthcare notification; and
generating a reformatted electronic healthcare notification to a selected patient of the healthcare provider.

3. The method of claim 1, further comprising:
providing statistics regarding receipt of the electronic healthcare notification to the organization at the website.

4. The method of claim 2, further comprising:
providing additional information regarding the electronic healthcare notification at the website to be viewed by the selected healthcare provider.

5. The method of claim 4, wherein the providing additional information includes providing access to search results regarding the healthcare notification.

6. The method of claim 5, further comprising:
providing communication with other healthcare providers at the website.

7. The method of claim 6, further comprising:
providing communication with the organization regarding adverse reactions at the website.

8. The method of claim 7, further comprising:
ordering medical samples in response to a received request by the selected healthcare provider at the website.

9. The method of claim 8, further comprising;
accessing previous electronic healthcare notifications associated with the selected healthcare provider at the website in response to a received request from the selected healthcare provider.

10. The method of claim 1, wherein the organization is selected from a group consisting of a pharmaceutical company, a medical device manufacturer, a medical equipment manufacturer, a government agency and a medical society,
and wherein the information regarding a healthcare notification is selected from a group consisting of a drug recall, a medical device recall, a drug usage warning, a medical device warning, medical equipment recall, medical equipment warning, biological threat and communicable threat.

11. A method to notify a plurality of healthcare providers of a medical event, the method comprising:
receiving electronically information regarding the medical event;
selecting a set of the plurality of healthcare providers to notify; and
notifying electronically the set of healthcare providers of the medical event.

12. The method of claim 11, further comprising:
determining whether each of the healthcare providers in the set of healthcare providers received the electronic notification of the medical event; and
mailing the notification of the medical event to the healthcare providers that did not electronically receive the electronic notifications of the medical event.

13. The method of claim 11, further comprising:
selecting a type of electronic notification to provide to each of the healthcare providers in the set of health care providers; and
formatting the information regarding the medical event in response to a selected type of electronic notification,
wherein the notifying electronically includes notifying each of the healthcare providers in the set of healthcare providers by the respective selected type of electronic notification.

14. The method of claim 13, further comprising:
allowing access to the set of healthcare providers to view further information regarding the medical event at a website.

15. The method of claim 14 further comprising:
determining when to electronically notify the set of health care providers of the medical event.

16. The method of claim 11, wherein the medical event is selected from a group consisting of a drug recall, a medical device recall, a drug usage warning a medical device warning, medical equipment recall, medical equipment warning, biological threat and communicable threat, and
wherein the receiving includes receiving information from an entity selected from a group consisting of a pharmaceutical company, a medical device manufacturer, a medical equipment manufacturer, a government agency and a medical society.

17. The method of claim 11, wherein the notifying electronically includes providing the information using a device selected from a group consisting of a mainframe computer, server, laptop computer, hand-held computer, personal digital assistant, a facsimile machine, a telephone, a cellular telephone, a pager, short message service (SMS) messaging device, e-mail device, an information appliance, or an equivalent.

18. A system to provide information regarding a medical event, the system comprising:
a storage device to store contact information regarding a plurality of healthcare providers and a corresponding preferred type of electronic communication;
a processor, coupled to the storage device;
the storage device to store executable instructions for controlling the processor; and
the processor is operative with the executable instructions to:
receive information regarding the medical event via the Internet;
determine a set of healthcare providers to receive information regarding the medical event from the plurality of healthcare providers;
determine a preferred type of communication for each of healthcare providers in the set of healthcare providers;
format the information regarding the medical event in response to the preferred type of communication for each of the healthcare providers in the set of healthcare providers; and
provide an electronic notification of the information regarding the medical event to each of the set of healthcare providers, each electronic notification formatted based on the corresponding preferred type of communication.

19. The system of claim 18, wherein the medical event is selected from a group consisting of a drug recall, a medical device recall, a drug usage warning a medical device warning, medical equipment recall, medical equipment warning, biological threat and communicable threat, and
wherein the received information is received from an organization selected from a group consisting of a pharmaceutical company, a medical device manufacturer, a medical equipment manufacturer, a government agency and a medical society.

20. The method of claim 19, wherein the electronic notification is selected from a group consisting of emailing, faxing, paging and text messaging.

21. A healthcare notification network comprising:
a first processing device to provide information regarding a medical event via the Internet;
a second processing device to receive the information, the second processing device to select a set of healthcare providers to notify from a plurality of healthcare providers, the second processing device formatting the information in response to a corresponding plurality of communication preferences of the set of healthcare providers; and
a third processing device to receive at least one notification formatted by the second processing device via the Internet, the third processing device to access further information regarding the medical event.

22. The healthcare notification network of claim 21, wherein the third processing device in response to a user selection registers at least one of the healthcare providers in the plurality of healthcare providers.

23. The healthcare notification network of claim 22, wherein the third processing device is used to access the second processing device to communicate with other healthcare providers.

24. The healthcare notification network of claim 23, wherein the third processing device is used to report adverse effects to another processing device.

25. The healthcare notification network of claim 21, wherein the second processing device provides a medical information alert portal website.

26. The healthcare notification network of claim 21, wherein the at least one notification formatted by the second processing device includes a link to one or more websites provided by the second processing device.

27. The healthcare notification network of claim 21, wherein the second processing device provides a tool to the first processing device that enables the inputting of the information regarding the medical event.
